(19) United States
(12) Patent Application Publication
(10) Pub. No.: US 2006/0220511 A1
(43) Pub. Date: Oct. 5, 2006

(54) Spark plug having ground electrode protruding member with inner and outer edges

(75) Inventors: Ken Hanashi, Handa-shi (JP); Shinichi Okabe, Aichi-ken (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 11/393,730

(22) Filed: Mar. 31, 2006

(30) Foreign Application Priority Data
Apr. 1, 2005 (JP) 2005-106429

(51) Int. Cl. H01T 13/20

(52) U.S. Cl. 313/141

(57) ABSTRACT

A spark plug includes a metal shell, an insulator, a center electrode, and a ground electrode. The insulator is retained in the metal shell. The center electrode is secured in the insulator and has an end portion that protrudes from the insulator and has an end edge. The ground electrode includes a base member fixed to the metal shell and a protruding member joined to the base member. The protruding member protrudes from a surface of the base member and has a hollow end face that faces the end portion of the center electrode through a spark gap. The end face of the protruding member has an inner edge and an outer edge, both of which face the end edge of the end portion of the center electrode. With the above configuration, the spark plug can induce spark discharges with a low discharge voltage while securing the ignition capability thereof.

### CROSS-REFERENCE TO RELATED APPLICATION

This application is based on and claims priority from Japanese Patent Application No. 2005-106429, filed on Apr. 1, 2005, the content of which is hereby incorporated by reference into this application.

### BACKGROUND OF THE INVENTION

1. Technical Field of the Invention

The present invention relates generally to spark plugs for use in internal combustion engines of automotive vehicles and cogeneration systems.

More particularly, the invention relates to a spark plug for an internal combustion engine which can induce spark discharges with a low discharge voltage while securing the capability thereof to ignite the air-fuel mixture (referred to as the ignition capability of the spark plug hereinafter).

2. Description of the Related Art

Conventional spark plugs for internal combustion engines generally include a center electrode and a ground electrode. The center and ground electrodes are arranged to face one another with a spark gap therebetween, so that spark discharges can be induced by applying a discharge voltage across the spark gap, thereby igniting the air-fuel mixture within a combustion chamber of the engine.

For such spark plugs, it is generally desired to reduce the spark gap, thereby lowering the discharge voltage (i.e., the voltage required to induce spark discharges across the spark gap). Further, through lowering the discharge voltage, constraints on design of the spark plug can be alleviated, thereby making it possible to minimize the spark plug.

However, reduction of the spark gap may cause, at the same time, growth of the flame kernel to be easily hampered. As a result, the ignition capability of the spark plug may be lowered by the reduction of the spark gap.

To solve such a contradiction, with reference to FIG. 18, the ground electrode 92 of a conventional spark plug 9 is configured to include a protruding member 921, which is shaped in a thin solid rod and made of a noble metal. With this configuration, it becomes possible to reduce the spark gap G between the protruding member 921 of the ground electrode 92 and the center electrode 93, in other words, to reduce the discharge voltage of the spark plug 9, while securing the ignition capability of the spark plug 9. (Such a ground electrode configuration is disclosed, for example, in Japanese Patent First Publication No. 2002-184551).

However, to meet recent requirements of increasing engine power output and improving fuel economy, it is desired to further lower discharge voltages of spark plugs while securing the ignition capabilities thereof.

Accordingly, on the basis of the above-described ground electrode configuration, a further improvement in spark plug structure is desired.

### SUMMARY OF THE INVENTION

The present invention has been made in view of the above-mentioned circumstances.

It is, therefore, a primary object of the present invention to provide a spark plug for an internal combustion engine which has an improved structure that enables the spark plug to induce spark discharges with a low discharge voltage while securing the ignition capability of the spark plug.

According to the present invention, a spark plug for an internal combustion engine is provided which includes a metal shell, an insulator, a center electrode, and a ground electrode.

The insulator is retained in the metal shell. The center electrode is secured in the insulator and has an end portion that protrudes from the insulator and has an end edge.

The ground electrode includes a base member fixed to the metal shell and a protruding member joined to the base member. The protruding member protrudes from a surface of the base member and has a hollow end face that faces the end portion of the center electrode through a spark gap. The end face of the protruding member has an inner edge and an outer edge, both of which face the end edge of the end portion of the center electrode.

With the above configuration, it is possible for the protruding member of the ground electrode to have a total length of edges, from which spark discharges start, almost twice that of a conventional ground electrode protruding member which has a solid rod shape and the same outer diameter. As a result, with the increased total length of edges, it becomes possible to lower the discharge voltage of the spark plug.

Further, with the above configuration, it is also possible to reduce the outer diameter of the protruding member of the ground electrode while securing the total length of edges thereof. As a result, it becomes possible to facilitate growth of the flame kernel through the reduction in the outer diameter of the protruding member, thereby enhancing the ignition capability of the spark plug.

Furthermore, with the above configuration, it is also possible to set a relatively large spark gap without increasing the discharge voltage of the spark plug. As a result, it becomes possible to increase the length of sparks making contact with the air-fuel mixture through the increase in the spark gap, thereby enhancing the ignition capability of the spark plug.

Accordingly, the spark plug according to the present invention has the capability to induce spark discharges with a low discharge voltage while securing the ignition capability thereof.

Preferably, in the above spark plug, |B1−B2|≦0.3 mm, where, B1 is the distance between P0 and P1 and B2 is the distance between P0 and P2. Further, P0 is any intersection between the end edge of the end portion of the center electrode and an arbitrary hypothetical plane that extends parallel to the longitudinal direction of the spark plug and intersects all of the end edge of the end portion of the center electrode and the inner and outer edges of the protruding member of the ground electrode; P1 is any intersection between the inner edge of the protruding member of the ground electrode and the arbitrary hypothetical plane; P2 is any intersection between the outer edge of the protruding member of the ground electrode and the arbitrary hypothetical plane.

Specifying the above dimensional relationship, it is possible to put both the inner and outer edges of the protruding member of the ground electrode to effective use. As a result, it becomes possible to reliably lower the discharge voltage of the spark plug through the effective use of both the inner and outer edges of the protruding member.

It is more preferable that |B1−B2|=0 in the above spark plug. In this case, since the distance B1 is equal to the distance B2, it is possible to equally utilize the inner and outer edges of the protruding member of the ground electrode, thereby making it possible to secure the durability of the protruding member while lowering the discharge voltage of the spark plug.

Preferably, in the above spark plug, the following dimensional relationships are further specified:
if A≧E1(A−E1)/2≦A/3, else
if A<E1, B1≦F,
where, A is the length of the longest straight line whose end points lie on the end edge of the end portion of the center electrode, E1 is the length of the longest straight line whose end points lie on the inner edge of the protruding member of the ground electrode, and F is the distance between the end portion of the center electrode and the base member of the ground electrode in the longitudinal direction of the spark plug.

Specifying the above dimensional relationships, growth of the flame kernel is prevented from being hampered and spark discharges between the end portion of the center electrode and the base member of the ground electrode are prevented from occurring. As a result, the ignition capability of the spark plug can be secured.

Preferably, in the above spark plug, the end edge of the end portion of the center electrode is shaped in a circle, and the protruding member of the ground electrode is shaped in a cylindrical tube so that the inner and outer edges of the protruding member are shaped in circles which are concentric with one another.

With the above configuration, it is possible to uniformly induce spark discharges from the entire circumferences of the inner and outer edges of the protruding member of the ground electrode, thereby making it possible to further lower the discharge voltage of the spark plug.

Preferably, in the above spark plug, the protruding member of the ground electrode has a protruding height D, which represents the distance between the end face of the protruding member and the base member of the ground electrode in the longitudinal direction of the spark plug, in a range of 0.3 to 1.5 mm.

If the protruding height D is less than 0.3 mm, growth of the flame kernel would be hampered by the base member of the ground electrode, thus making it difficult to secure the ignition capability of the spark plug.

On the contrary, if the protruding height D is greater than 1.5 mm, the temperature of the protruding member would become too high, thus making it difficult to suppress wear of the protruding member due to heat.

Preferably, in the above spark plug, the distance C between the protruding member of the ground electrode and the end portion of the center electrode in the longitudinal direction of the spark plug is in a range of 0.5 to 1.5 mm.

If the distance C is less than 0.5 mm, growth of the flame kernel would be hampered by both the protruding member of the ground electrode and the end portion of the center electrode and the length of sparks making contact with the air-fuel mixture would become too short, thus making it difficult to secure the ignition capability of the spark plug.

On the contrary, if the distance C is greater than 1.5 mm, it would be difficult to lower the discharge voltage of the spark plug.

Preferably, in the above spark plug, the end portion of the center electrode is made of an Ir-based alloy which includes Ir in an amount of not less than 50% by weight and at least one additive and has a melting point of not lower than 2000° C. Further, the additive is preferably selected from Pt, Rh, Ni, W, Pd, Ru, Re, Al, Al₂O₃, Y, and Y₂O₃.

Specifying the material of the end portion of the center electrode as above, it is possible to secure both the durability of the end portion and the ignition capability of the spark plug. As a result, it becomes possible to ensure a long service life and high reliability of the spark plug.

Preferably, in the above spark plug, the protruding member of the ground electrode is made of a Pt-based alloy which includes Pt in an amount of not less than 50% by weight and at least one additive and has a melting point of not lower than 1500° C. The additive is preferably selected from Ir, Rh, Ni, W, Pd, Ru, and Re.

Specifying the material of the protruding member of the ground electrode as above, it is possible to secure both the durability of the protruding member and the ignition capability of the spark plug. As a result, it becomes possible to ensure a long service life and high reliability of the spark plug.

### BRIEF DESCRIPTION OF THE DRAWINGS

The present invention will be understood more fully from the detailed description given hereinafter and from the accompanying drawings of the preferred embodiments of the invention, which, however, should not be taken to limit the invention to the specific embodiments but are for the purpose of explanation and understanding only.

In the accompanying drawings:

FIG. 1 is a partially cross-sectional side view showing an end portion of a spark plug according to the first embodiment of the invention;

FIG. 2 is a cross-sectional view illustrating dimensional parameters in the spark plug of FIG. 1;

FIG. 3 is a view along the longitudinal direction of the spark plug of FIG. 1 from a hypothetical plane, which is perpendicular to the longitudinal direction and intersects an end portion of a center electrode of the spark plug, toward a protruding member of a ground electrode of the spark plug;

FIG. 4 is a cross-sectional view illustrating inner and outer edges of a ground electrode protruding member both of which are shaped in an incomplete circle;

FIG. 5 is a view illustrating the feasible region S for arrangement of an inner edge of the protruding member of the ground electrode in the spark plug of FIG. 1;

FIGS. 6A-6D are schematic views illustrating a laser welding process for joining the protruding member to a base member of the ground electrode of the spark plug of FIG. 1;

FIG. 7A is a partially cross-sectional side view showing an end portion of a spark plug according to the second embodiment of the invention;

FIG. 7B is a view along the longitudinal direction of the spark plug of FIG. 7A from a hypothetical plane, which is perpendicular to the longitudinal direction and intersects an end portion of a center electrode of the spark plug, toward a protruding member of a ground electrode of the spark plug;

FIG. 8A is a partially cross-sectional side view showing an end portion of a spark plug according to the third embodiment of the invention;

FIG. 8B is a view along the longitudinal direction of the spark plug of FIG. 8A from a hypothetical plane, which is perpendicular to the longitudinal direction and intersects an end portion of a center electrode of the spark plug, toward a protruding member of a ground electrode of the spark plug;

FIG. 9 is a schematic view illustrating various shapes which inner and outer edges of a ground electrode protruding member may have;

FIGS. 10A-10E are schematic views illustrating various shapes which a ground electrode protruding member may have;

FIGS. 11A-11D are schematic views illustrating various arrangements which base and protruding members of a ground electrode may have;

FIGS. 12A-12C are schematic views illustrating a method of joining a protruding member to a base member of a ground electrode;

FIGS. 13A-13C are schematic views illustrating a method of forming a protruding member in a ground electrode;

FIG. 14 is a graphical representation showing the relationship between the dimensional parameter |B1−B2| and the discharge voltage of the spark plug of FIG. 1;

FIG. 15 is a graphical representation showing the relationship between the dimensional parameter D and the ignition capability of the spark plug of FIG. 1;

FIG. 16 is a graphical representation showing the relationship between the dimensional parameter (A−E1) and the ignition capability of the spark plug of FIG. 1;

FIG. 17 is a graphical representation showing the relationship between the dimensional parameter C and the ignition capability of the spark plug of FIG. 1; and

FIG. 18 is a partially cross-sectional side view showing an end portion of a conventional spark plug.

### DESCRIPTION OF THE PREFERRED EMBODIMENTS

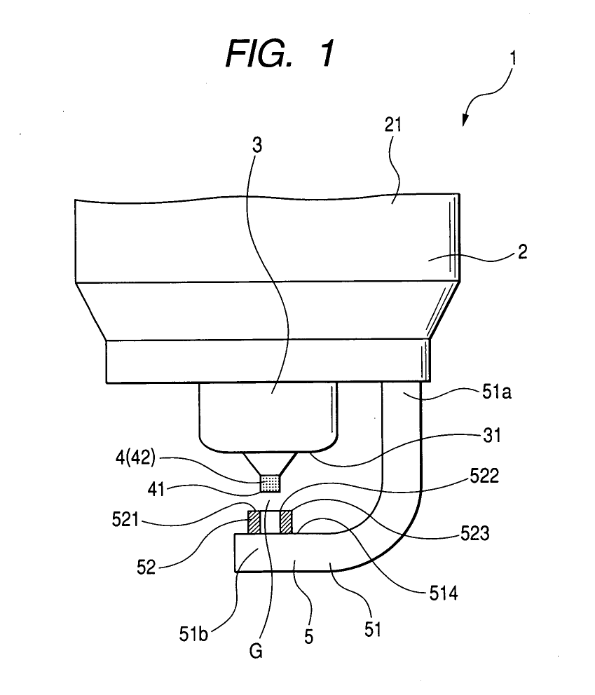

The preferred embodiments of the present invention will be described hereinafter with reference to FIGS. 1-17.

It should be noted that, for the sake of clarity and understanding, identical components having identical functions in different embodiments of the invention have been marked, where possible, with the same reference numerals in each of the figures.

### First Embodiment

FIG. 1 shows the overall structure of a spark plug 1 according to the first embodiment of the invention.

The spark plug 1 is designed for use in an internal combustion engine of an automotive vehicle or a cogeneration system. More specifically, the spark plug 1 is designed to ignite the air-fuel mixture within a combustion chamber of the engine.

As shown in FIG. 1, the spark plug 1 includes a tubular metal shell 2, an insulator 3, a center electrode 4, and a ground electrode 5.

The tubular metal shell 2 has a male threaded portion 21 on an outer periphery thereof, through which the spark plug 1 is to be installed in the combustion chamber of the engine. The metal shell 2 is made of a conductive metal material, such as low-carbon steel.

The insulator 3 is retained in the metal shell 2 such that an end portion 31 thereof protrudes from the metal shell 2. The insulator 3 is made of a ceramic material, such as alumina (Al₂O₃).

The center electrode 4 is secured in the insulator 3, so that it is electrically isolated from the metal shell 2.

The center electrode 4 has a cylindrical end portion 42 that protrudes from the end portion 31 of the insulator 3. The end portion 42 of the center electrode 4 is made, preferably, of an Ir-based alloy which includes Ir in an amount of not less than 50% by weight and at least one additive and has a melting point of not lower than 2000° C. The additive is, preferably, selected from Pt, Rh, Ni, W, Pd, Ru, Re, Al, Al₂O₃, Y, and Y₂O₃.

Other portions of the center electrode 4 may be made of a highly heat conductive metal material such as Cu as the core material and a highly heat-resistant, corrosion-resistant metal material such as a Ni-based alloy as the cladding material.

The end portion 42 of the center electrode 4 is joined to the other portions by, for example, laser welding.

The ground electrode 5 includes a base member 51 and a protruding member 52.

The base member 51 of the ground electrode 5 is L-shaped and made, for example, of a Ni-based alloy. The base member 51 has a base end portion 51a fixed to the metal shell 2 and a tip end portion 51b aligned with the end portion 42 of the center electrode 4 in the longitudinal direction of the spark plug 1.

The protruding member 52 of the ground electrode 5 is provided on a side face 514 of the tip end portion 51b of the base member 51 such that the protruding member 52 faces the end portion 42 of the center electrode 4 through a spark gap G in the longitudinal direction of the spark plug 1.

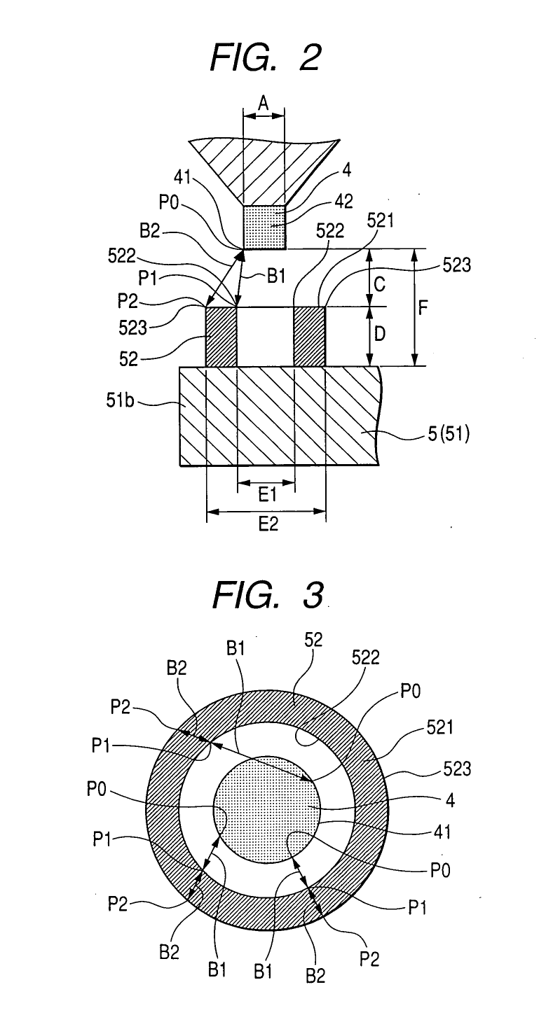

More specifically, referring further to FIGS. 2 and 3, the protruding member 52 of the ground electrode 5 is tubular in shape and has an annular end face 521 facing the end portion 42 of the center electrode 4. The protruding member 52 further has a circular inner edge 522 formed on the inner side of the annular end face 521 and a circular outer edge 523 formed on the outer side of the same.

The protruding member 52 of the ground electrode 5 is made, preferably, of a Pt-based alloy which includes Pt in an amount of not less than 50% by weight and at least one additive and has a melting point of not lower than 1500° C. The additive is, preferably, selected from Ir, Rh, Ni, W, Pd, Ru, and Re.

The protruding member 52 of the ground electrode 5 is joined to the base member 51 by, for example, laser welding.

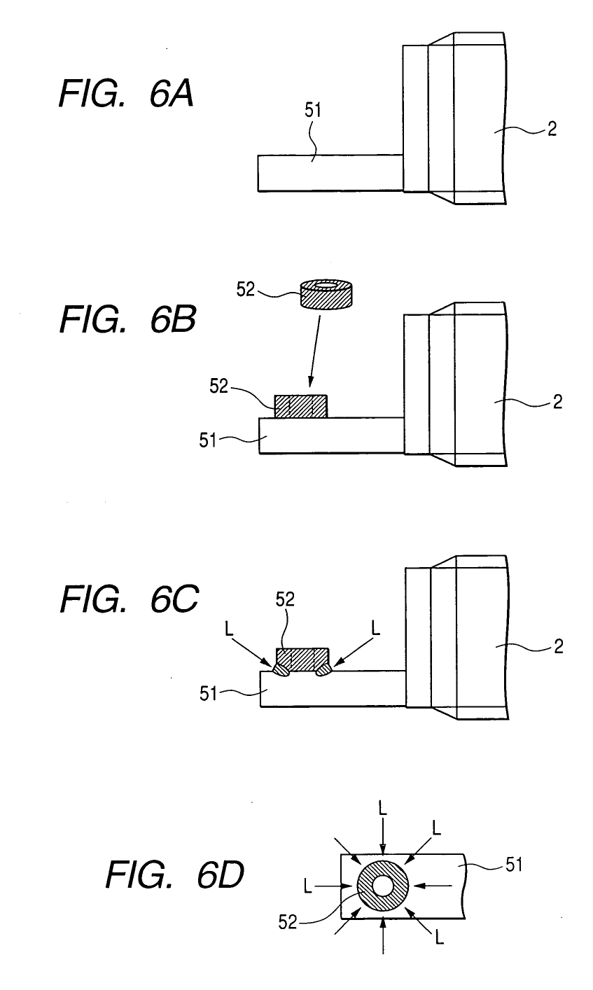

The laser welding process may be performed as follows. First, referring to FIGS. 6A and 6B, the protruding member 52 is temporarily fixed to the base member 51, which has not been bent to have the L-shape, by resistance welding. Then, referring to FIGS. 6C and 6D, a laser beam L is irradiated to the outer periphery of contacting portions of the base member 51 and the protruding member 52 over the entire circumference, thereby joining together the two members 51 and 52. After that, the base member 51 is bent to have the L-shape as shown in FIG. 1, thereby allowing the end face 521 of the protruding member 52 to face the end portion 42 of the center electrode 4.

After having described the overall structure of the spark plug 1, dimensional relationships, which are critical to the performance of the spark plug 1, will be described hereinafter.

In the spark plug 1, referring again to FIGS. 2 and 3, the dimensional relationship of |B1−B2|≦0.3 mm is specified. Here, B1 represents the distance between P0 and P1 and B2 represents the distance between P0 and P2. Further, P0 represents any intersection between an end edge 41 of the end portion 42 of the center electrode 4, which faces the protruding member 52 of the ground electrode 5, and an arbitrary hypothetical plane that extends parallel to the longitudinal direction of the spark plug 1 and intersects all of the end edge 41 of the end portion 42 of the center electrode 4 and the inner and outer edges 522 and 523 of the protruding member 52 of the ground electrode 5; P1 represents any intersection between the inner edge 522 of the protruding member 52 of the ground electrode 5 and the arbitrary hypothetical plane; P2 represents any intersection between the outer edge 523 of the protruding member 52 of the ground electrode 5 and the arbitrary hypothetical plane.

An example of such an arbitrary hypothetical plane is the paper surface of FIG. 2. In other words, FIG. 2 shows the cross-sections of the end portion 42 of the center electrode 4 and the protruding member 52 of the ground electrode 5 on one of such hypothetical planes.

Moreover, though there are various ways of making such an arbitrary hypothetical plane and selecting the intersections P0, P1, and P2 as shown in FIG. 3, the relationship of |B1−B2|≦0.3 mm is satisfied in all cases.

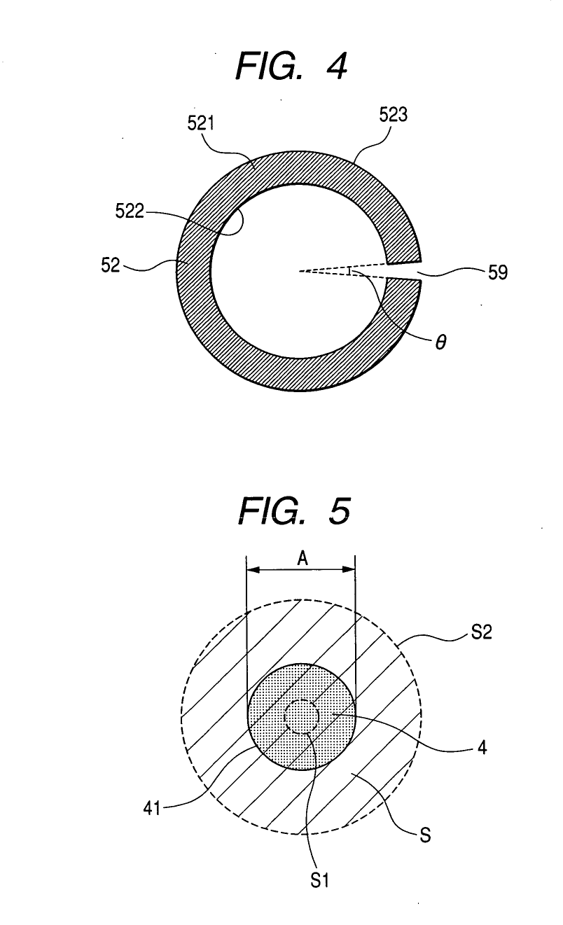

Furthermore, though each of the end edge 41 of the end portion 42 of the center electrode 4 and the inner and outer edges 552 and 553 of the protruding member 52 of the ground electrode 5 is shaped in a complete circle in the present embodiment, each of those may also be shaped in an incomplete circle as shown in FIG. 4. In this case, the angular range θ of chips 59 on the incomplete-circular edges is, preferably, less than 10°

In the spark plug 1, the following dimensional relationships are further specified: if A≧E1, (A−E1)/2≦A/3; else if A<E1, B1≦F. Here, E1 represents the diameter of the inner edge 522 of the protruding member 52 of the ground electrode 5, E2 represents the diameter of the outer edge 523 of the protruding member 52, A represents the diameter of the end edge 41 of the end portion 42 of the center electrode 4, and F represents the distance between the end portion 42 of the center electrode 4 and the tip end portion 51b of the base member 51 of the ground electrode 5 in the longitudinal direction of the spark plug 1.

The above dimensional relationships represent the feasible region S for arrangement of the inner edge 522 of the protruding member 52 of the ground electrode 5 with respect to the end edge 41 of the end portion 42 of the center electrode 4. Specifically, when viewed along the longitudinal direction of the spark plug 1, the feasible region S lies between an inner limit line S1 and an outer limit line S2, as shown in FIG. 5. The inner limit line S1 is a circle which represents the dimensional relationship of A/3=(A−E1)/2. In other words, in the case of the diameter E1 of the inner edge 522 being not greater than the diameter A of the end edge 41 (i.e., A≧E1), the inner edge 522 can be arranged inside of the end edge 41 by at most A/3. On the other hand, the outer limit line S2 is a circle which represents the dimensional relationship of B1=F. In other words, in the case of the diameter E1 of the inner edge 522 being greater than the diameter A of the end edge 41 (i.e., A<E1), the inner edge 522 can be arranged outside of the end edge 41 under the constraint of B1≦F.

In the spark plug 1, the protruding member 52 of the ground electrode 5, which is joined to the base member 51 of the ground electrode 5, is shaped in a cylindrical tube. Accordingly, the inner and outer edges 522 and 523 of the protruding member 52 are shaped in circles which are concentric with one another. Moreover, the end edge 41 of the end portion 42 of the center electrode 4 is also shaped in a circle.

In the spark plug 1, the protruding member 52 of the ground electrode 5 has a protruding height D in the range of 0.3 to 1.5 mm. The protruding height D here represents, as shown in FIG. 2, the distance from the tip end portion 51b of the base member 52 of the ground electrode 5 to the end face 521 of the protruding member 52 in the longitudinal direction of the spark plug 1.

In the spark plug 1, the distance C between the protruding member 52 of the ground electrode 5 and the end portion 42 of the center electrode 4 in the longitudinal direction of the spark plug 1 is in the range of 0.5 to 1.5 mm.

The above-described spark plug 1 according to the present embodiment has the following advantages.

In the spark plug 1, the protruding member 52 of the ground electrode 5 has the inner and outer edges 522 and 523, both of which face the end edge 41 of the end portion 42 of the center electrode 4.

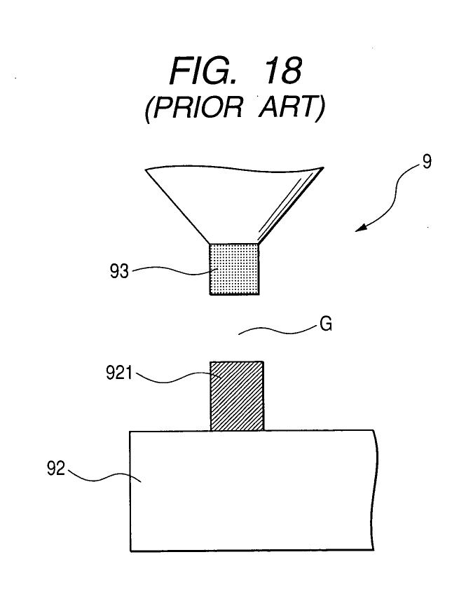

With such a configuration, it is possible for the protruding member 52 of the ground electrode 5 to have a total length of edges, from which spark discharges start, almost twice that of a conventional ground electrode protruding member which has a solid rod shape as shown in FIG. 18 and the same outer diameter as the protruding member 52. As a result, with the increased total length of edges, it becomes possible to lower the discharge voltage of the spark plug 1.

Further, with the above configuration, it is also possible to reduce the outer diameter of the protruding member 52 while securing the total length of edges thereof. As a result, it becomes possible to facilitate growth of the flame kernel through the reduction in the outer diameter of the protruding member 52, thereby enhancing the ignition capability of the spark plug 1.

Furthermore, with the above configuration, it is also possible to set a relatively large spark gap G without increasing the discharge voltage of the spark plug 1. As a result, it becomes possible to increase the length of sparks making contact with the air-fuel mixture through the increase in the spark gap G, thereby enhancing the ignition capability of the spark plug 1.

In the spark plug 1, the dimensional relationship of |B1−B2|≦0.3 mm is specified.

Specifying the above dimensional relationship, it is possible to put both the inner and outer edges 522 and 523 of the protruding member 52 of the ground electrode 5 to effective use. More specifically, through specifying the range of the difference between the distances B1 and B2 as above, it becomes possible to reliably induce spark discharges both between the inner edge 522 and the end edge 41 of the end portion 42 of the center electrode 4 and between the outer edge 523 and the end edge 41. As a result, it becomes possible to reliably lower the discharge voltage of the spark plug 1 through the effective use of both the inner and outer edges 522 and 52.

In the spark plug 1, the dimensional relationships of (A−E1)/2≦A/3 if A≧E1 and B1≦F if A<E1 are specified.

Specifying the above dimensional relationships, growth of the flame kernel is prevented from being hampered and spark discharges between the end portion 41 of the center electrode 4 and the base member 51 of the ground electrode 5 are prevented from occurring. As a result, the ignition capability of the spark plug 1 can be secured.

In the spark plug 1, the inner and outer edges 522 and 523 of the protruding member 52 of the ground electrode 5 are shaped in circles which are concentric with one another. Moreover, the end edge 41 of the end portion 42 of the center electrode 4 is also shaped in a circle.

With the above configuration, it is possible to uniformly induce spark discharges from the entire circumferences of the inner and outer edges 522 and 523, thereby making it possible to further lower the discharge voltage of the spark plug 1.

In the spark plug 1, the protruding member 52 has the protruding height D in the range of 0.3 to 1.5 mm.

Specifying the range of the protruding height D as above, growth of the flame kernel is prevented from being hampered by the base member 51 of the ground electrode 5 and the temperature of the protruding member 52 is prevented from becoming too high. As a result, the ignition capability of the spark plug 1 can be secured and wear of the protruding member 52 due to heat can be suppressed.

In the spark plug 1, the distance C between the protruding member 52 of the ground electrode 5 and the end portion 42 of the center electrode 4 in the longitudinal direction of the spark plug 1 is in the range of 0.5 to 1.5 mm.

Specifying the range of the distance C as above, growth of the flame kernel is prevented from being hampered by both the protruding member 52 and the end portion 42, the length of sparks making contact with the air-fuel mixture is prevented from becoming too short, and the spark gap G is prevented from becoming too large. As a result, the ignition capability of the spark plug 1 can be secured and the discharge voltage of the spark plug 1 can be lowered.

In the spark plug 1, the end portion 42 of the center electrode 4 is made, preferably, of an Ir-based alloy which includes Ir in an amount of not less than 50% by weight and at least one additive and has a melting point of not lower than 2000° C. The additive is, preferably, selected from Pt, Rh, Ni, W, Pd, Ru, Re, Al, Al₂O₃, Y, and Y₂O₃.

Specifying the material of the end portion 42 of the center electrode 4 as above, it is possible to secure both the durability of the end portion 42 and the ignition capability of the spark plug 1. As a result, it becomes possible to ensure a long service life and high reliability of the spark plug 1.

In the spark plug 1, the protruding member 52 of the ground electrode 5 is made, preferably, of a Pt-based alloy which includes Pt in an amount of not less than 50% by weight and at least one additive and has a melting point of not lower than 1500° C. The additive is, preferably, selected from Ir, Rh, Ni, W, Pd, Ru, and Re.

Specifying the material of the protruding member 52 of the ground electrode 5 as above, it is possible to secure both the durability of the protruding member 52 and the ignition capability of the spark plug 1. As a result, it becomes possible to ensure a long service life and high reliability of the spark plug 1.

Accordingly, the spark plug 1 according to the present embodiment has the capability to induce spark discharges with a low discharge voltage while securing the ignition capability thereof.

The above-described advantages of the spark plug 1 have been confirmed through the experiments to be described below.

Experiment 1

This experiment was conducted to confirm the effect of the present invention on discharge voltage reduction.

In the experiment, sample spark plugs, which had the same structure as the spark plug 1 but various |B1−B2| and C, were tested in an atmosphere of 0.6 MPa to measure the discharge voltages Vr1 thereof. In addition, in each of those sample spark plugs, A was 0.5 mm and D was 0.8 mm.

Further, for the purpose of comparison, another sample spark plug, which had the same structure as the conventional spark plug 9 shown in FIG. 18, was also tested in the atmosphere of 0.6 MPa to measure the discharge voltage Vr2 thereof. In addition, in the sample spark plug, the solid-rod-shaped protruding member had an outer diameter of 0.5 mm and a protruding height of 0.8 mm.

FIG. 14 shows the test results, where the horizontal axis represents |B1−B2|, while the vertical one represents relative discharge voltage Vr1/Vr2. Further, in FIG. 14, the plots of “□” indicate the relative discharge voltages of the sample spark plugs in which C=0.5 mm, the plots of “◯” indicate those of the sample spark plugs in which C=1.0 mm, and the plots of “Δ” indicate those of the sample spark plugs in which C=1.5 mm.

It can be seen from FIG. 14 that when |B1−B2|≦0.3 mm, Vr1/Vr2<1.0 regardless of C.

In other words, the discharge voltage of the spark plug 1 is lowered through specifying the dimensional relationship of |B1−B2|≦0.3.

Experiment 2

This experiment was conducted to determine the effect of D on the ignition capability of the spark plug 1.

Sample spark plugs were fabricated which had the same structure as the spark plug 1 but various D. In addition, in each of those sample spark plugs, A was 0.55 mm, C was 0.9 mm, E1 was 0.9 mm, E2 was 1.3 mm, B1 was 0.98 mm, B2 was 0.91 mm, and |B1−B2| was 0.07 mm.

Further, sample spark plugs having the same structure as the conventional spark plug 9 shown in FIG. 18 were also fabricated for the purpose of comparison. In each of those sample spark plugs, the solid-rod-shaped protruding member had an outer diameter of 0.9 mm.

All the sample spark plugs were tested, using an automotive engine that had a displacement of 1.8 L and four in-line cylinders, at an engine rotational speed of 800 rpm. The ignition capabilities of the sample spark plugs were evaluated in terms of lean limit air/fuel ratio.

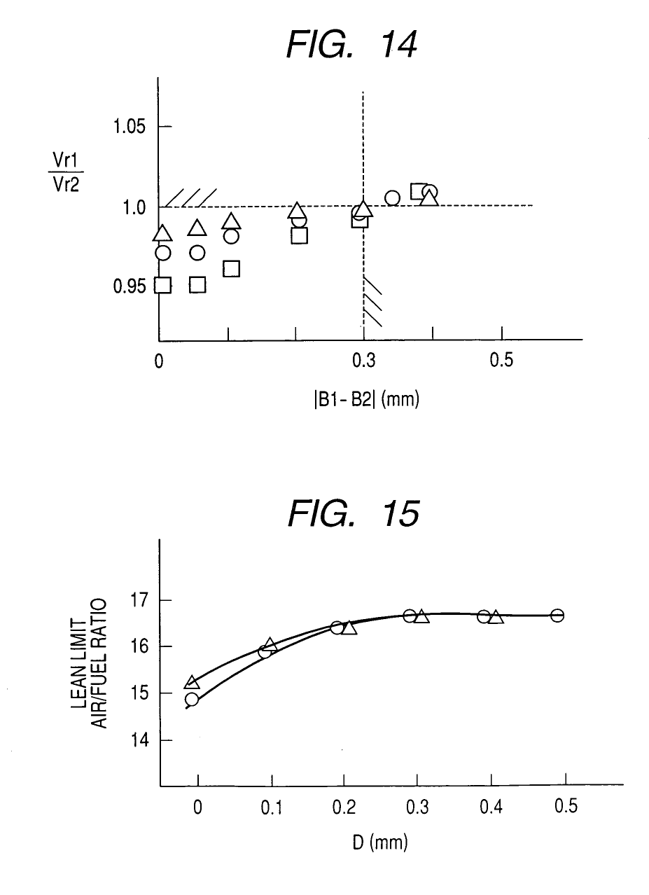

FIG. 15 shows the test results, where the plots of “Δ” indicate the results with the sample spark plugs having the same structure as the spark plug 1, and the plots of “◯” indicate those with the sample spark plugs having the same structure as the conventional spark plug 9.

As seen from FIG. 15, when D≧0.3 mm, the lean limit air/fuel ratios of the sample spark plugs were kept at a high level regardless of spark plug structure.

In other words, the ignition capability of the spark plug 1 is secured through specifying D≧0.3 mm.

Further, it can also be seen from FIG. 15 that when D<0.3 mm, the lean limit air/fuel ratios of the sample spark plugs having the same structure as the spark plug 1 were higher than those of the sample spark plugs having the same structure as the conventional spark plug 9.

In other words, the ignition capability of the spark plug 1 is higher than that of the conventional spark plug 9.

Experiment 3

This experiment was conducted to determine the effect of (A−E1) on the ignition capability of the spark plug 1.

Sample spark plugs were fabricated which had the same structure as the spark plug 1 but various E1. In addition, in each of those sample spark plugs, A was 0.7 mm, C was 0.8 mm, D was 0.8 mm, and E2 was 1.0 mm.

All the sample spark plugs were tested in the same way as in the Experiment 2. The ignition capabilities of the sample spark plugs were evaluated in terms of lean limit air/fuel ratio.

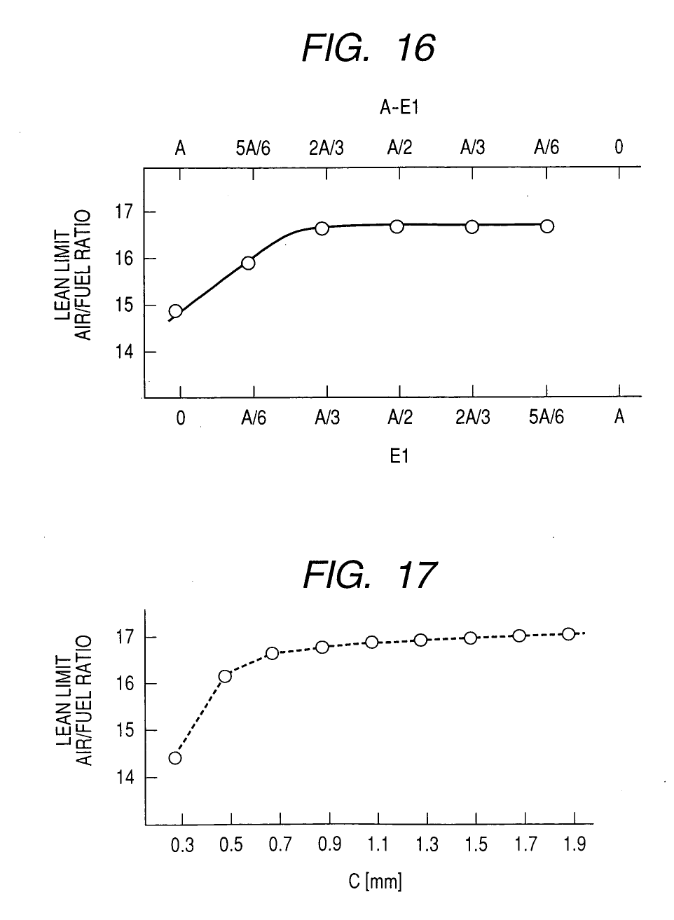

FIG. 16 shows the test results, where the bottom horizontal axis represents E1, the top horizontal axis represents (A−E1), and the vertical axis represents lean limit air/fuel ratio.

As seen form FIG. 16, when (A−E1)≦(2 A/3), the lean limit air/fuel ratios of the sample spark plugs were kept at a high level.

In other words, the ignition capability of the spark plug 1 is secured through specifying the dimensional relationship of (A−E1)/2≦A/3.

Experiment 4

This experiment was conducted to determine the effect of C on the ignition capability of the spark plug 1.

Sample spark plugs were fabricated which had the same structure as the spark plug 1 but various C. In addition, in each of those sample spark plugs, A was 0.55 mm, D was 0.8 mm, E1 was 0.9 mm, E2 was 1.3 mm, and |B1−B2| was 0.07 mm.

All the sample spark plugs were tested in the same way as in the Experiment 2. The ignition capabilities of the sample spark plugs were evaluated in terms of lean limit air/fuel ratio.

FIG. 17 shows the test results, where the horizontal axis represents C, while the vertical one represents lean limit air/fuel ratio.

As seen form FIG. 17, when 0.5≦C, the lean limit air/fuel ratios of the sample spark plugs were kept at a high level.

In other words, the ignition capability of the spark plug 1 is secured through specifying 0.5≦C.

### Second Embodiment

This embodiment provides a spark plug la that has almost the same structure as the spark plug 1 according to the first embodiment. Accordingly, only the differences in structure therebetween will be described below.

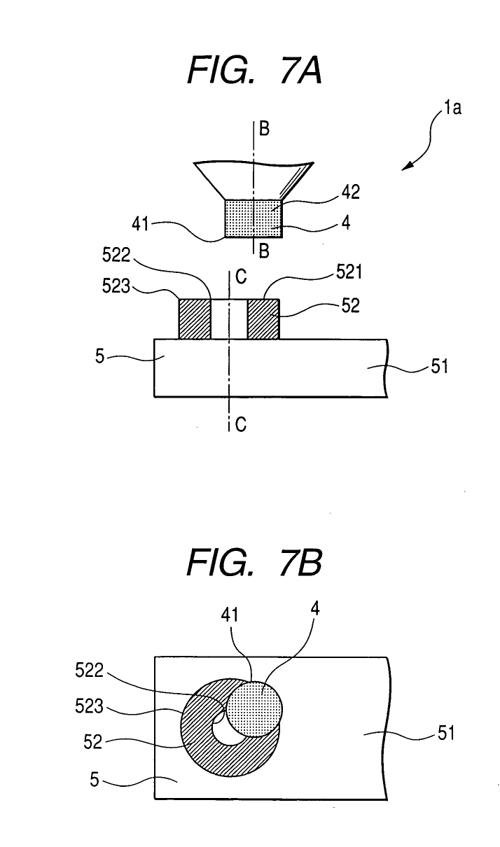

Referring to FIG. 7A, in the spark plug 1a, the axis B-B of the end portion 42 of the center electrode 4 does not coincide with the axis C-C of the protruding member 52 of the ground electrode 5.

In other words, when viewed along the longitudinal direction of the spark plug 1a, the common center of the inner and outer edges 522 and 523 of the protruding member 52 of the ground electrode 5 are not coincident with the center of the end edge 41 of the end portion 42 of the center electrode 4, as shown in FIG. 7B.

The deviation between the two axes B-B and C-C is, preferably, less than 0.5 mm, so as to provide the spark plug 1a with the same advantages as the spark plug 1.

### Third Embodiment

This embodiment provides a spark plug 1b that has almost the same structure as the spark plug 1 according to the first embodiment. Accordingly, only the differences in structure therebetween will be described below.

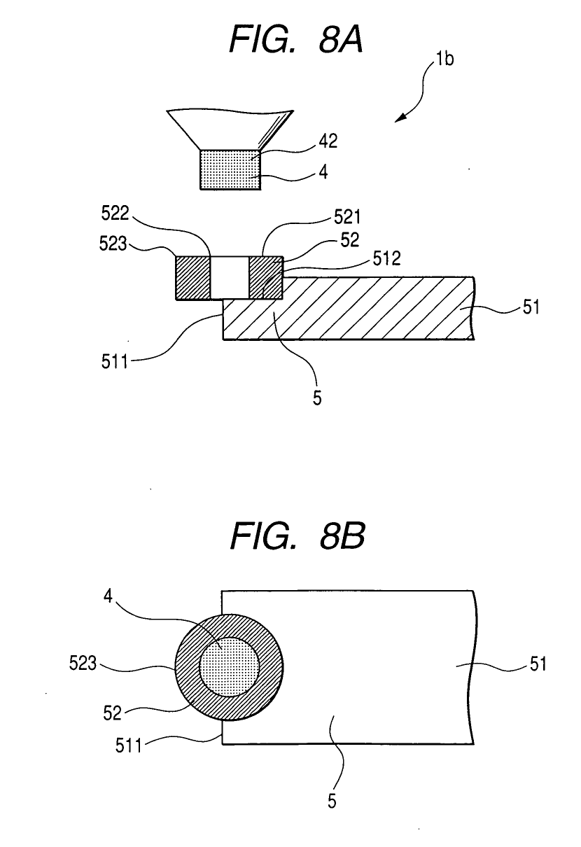

Referring to FIGS. 8A and 8B, in the spark plug 1b, the base member 51 of the ground electrode 5 has a semi-circular step 512 formed at a tip end 511 of the base member 51.

The protruding member 52 of the ground electrode 5 is disposed on the semi-circular step 512 of the base member 51 such that the protruding member 52 protrudes from the tip end 511 of the base member 51.

The spark plug 1b has the same advantages as the spark plug 1.

### Fourth Embodiment

This embodiment illustrates various shapes which the inner and outer edges 522 and 523 of the protruding member 52 of the ground electrode 5 may have.

As described previously, in the first embodiment, the inner and outer edges 522 and 523 of the protruding member 52 are shaped in circles which are concentric with one another.

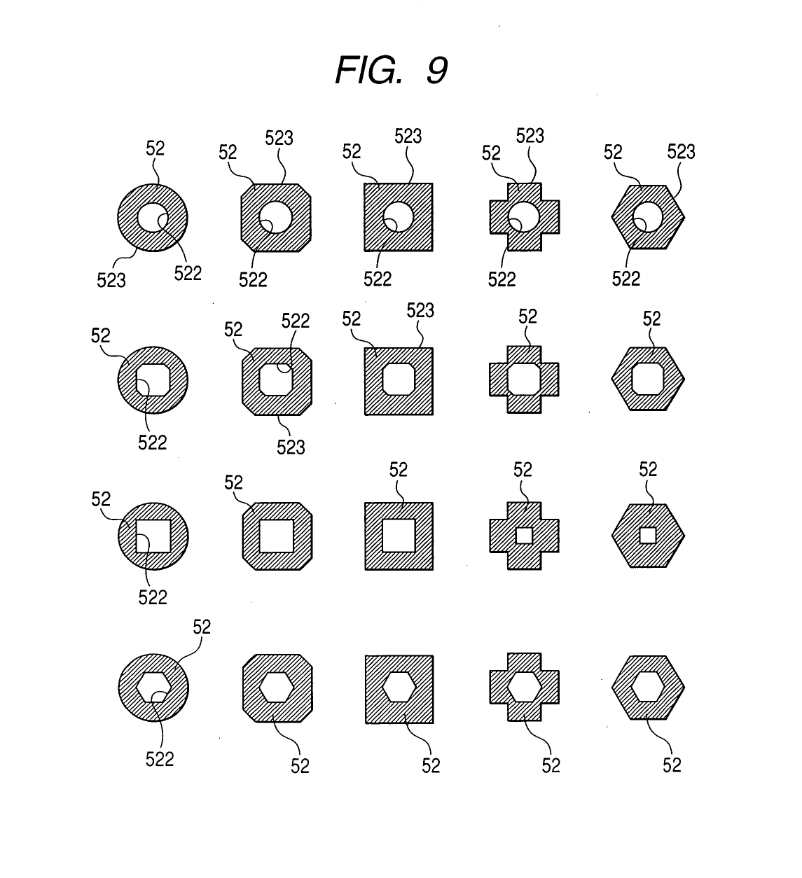

However, as shown in FIG. 9, the inner and outer edges 522 and 523 of the protruding member 52 may have various other shapes, such as a quadrangle, a hexagon, an octagon, and a cross.

With the above-described and any other possible shapes of the inner edge 522 and/or the outer edge 523 of the protruding member 52, it is still possible to provide the spark plug 1 with the same advantages as with the circular shapes of the two edges 522 and 523.

### Fifth Embodiment

This embodiment illustrates various shapes which the protruding member 52 of the ground electrode 5 may have.

As described previously, in the first embodiment, the protruding member 52 of the ground electrode 5 is shaped in a cylindrical tube.

However, the protruding member 52 of the ground electrode 5 may have various other shapes.

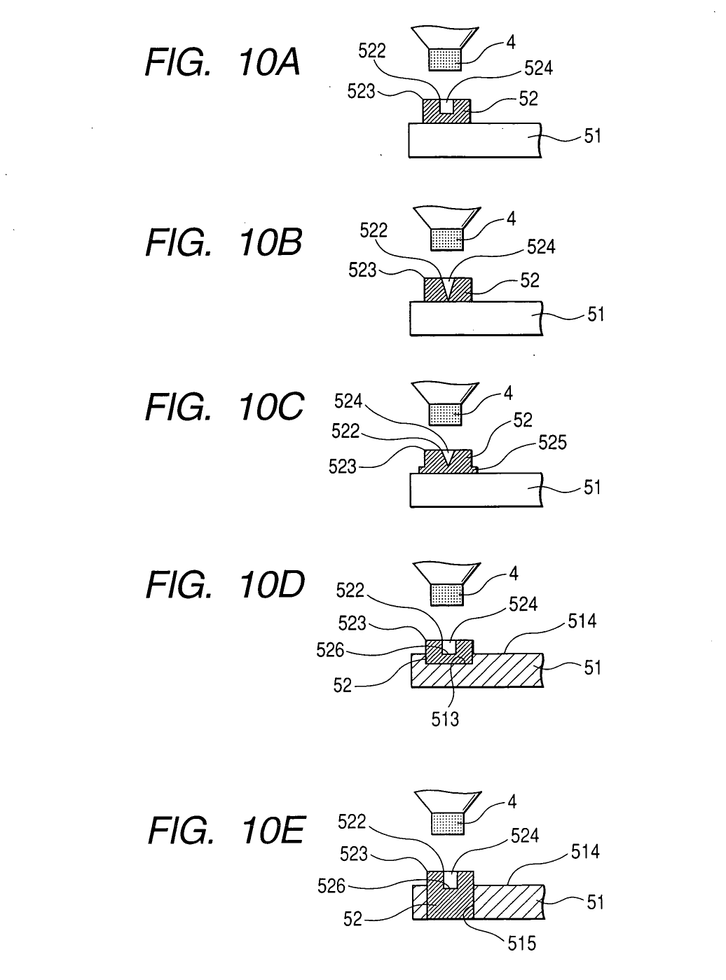

For example, as shown in FIG. 10A, the protruding member 52 may be in the shape of a rod that has a cylindrical recess 524 centrally formed therein.

As shown in FIG. 10B, the protruding member 52 may also be in the shape of a rod that has a conical recess 524 centrally formed therein.

As shown in FIG. 10C, the protruding member 52 may also be in the shape of a rod that has a conical recess 524 centrally formed therein and an extension 525 formed at a bottom end thereof. The extension 525 extends radially outward to protrude from the outer edge 523 of the protruding member 52 in the radial direction.

As shown in FIG. 10D, the protruding member 52 may be in the shape of a rod having a centrally-formed cylindrical recess 524 and fitted in a recess 513 formed in the base member 51 of the ground electrode 5 such that a bottom face 526 of the recess 524 lies on the same plane as the side face 514 of the base member 51.

As shown in FIG. 10E, the protruding member 52 may be in the shape of a rod having a centrally-formed cylindrical recess 524 and have a relatively large axial length so that it can be fitted in a through-bore 515 formed in the base member 51 of the ground electrode 5 with a bottom face 526 of the recess 524 lying on the same plane as the side face 514 of the base member 51.

With the above-described and any other possible shapes of the protruding member 52, it is still possible to provide the spark plug 1 with the same advantages as with the cylindrical-tube shape.

### Sixth Embodiment

This embodiment illustrates various arrangements of the base member 51 and the protruding member 52 of the ground electrode 5.

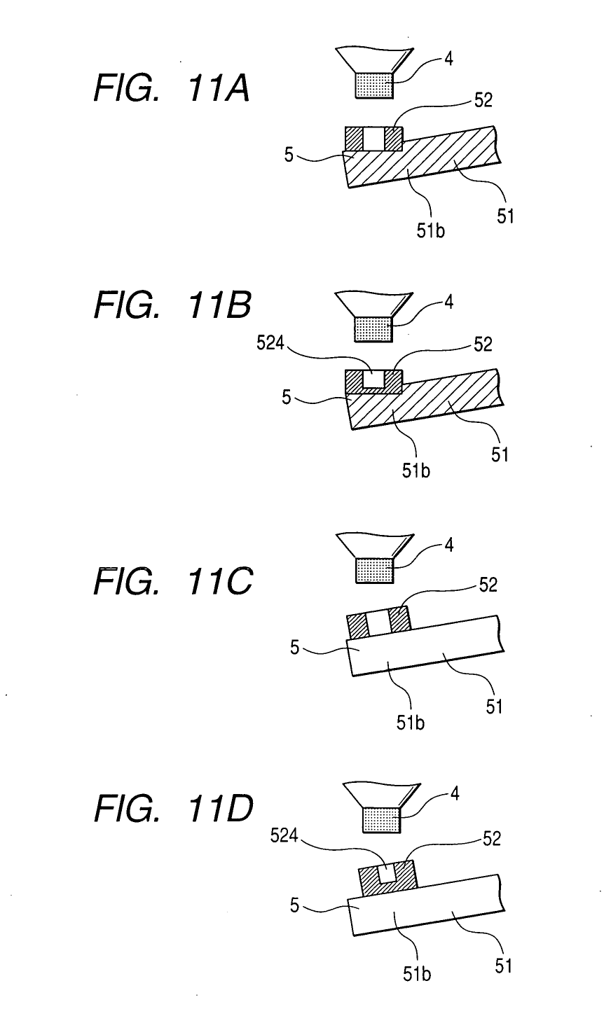

As shown in FIGS. 11A-11D, the base member 51 may be so arranged that the tip end portion 51b thereof extends obliquely with respect to the radial direction of the center electrode 4. The difference between the extending direction of the tip end portion 51b and the radial direction of the center electrode 4 is, preferably, less than 5°.

Further, as shown in FIGS. 11A and 11B, the protruding member 52 may be so joined to the tip end portion 51b of the base member 51 that the axis of the protruding member 52 coincides with that of the center electrode 4. In other words, the axis of the protruding member 52 is not perpendicular to the extending direction of the tip end portion 51b of the base member 51.

Otherwise, as shown in FIGS. 11C and 11D, the protruding member 52 may be so joined to the tip end portion 51b of the base member 51 that the axis of the protruding member 52 is perpendicular to the extending direction of the tip end portion 51b of the base member 51. In other words, the axis of the protruding member 52 is not coincident with that of the center electrode 4.

Furthermore, the protruding member 52 may be in the shape of a cylindrical tube as shown in FIGS. 11A and 11C. Otherwise, it may be in the shape of a rod having a centrally-formed cylindrical recess 524 as shown in FIGS. 11B and 11D.

### Seventh Embodiment

This embodiment illustrates a method of joining the protruding member 52 to the base member 51 of the ground electrode 5.

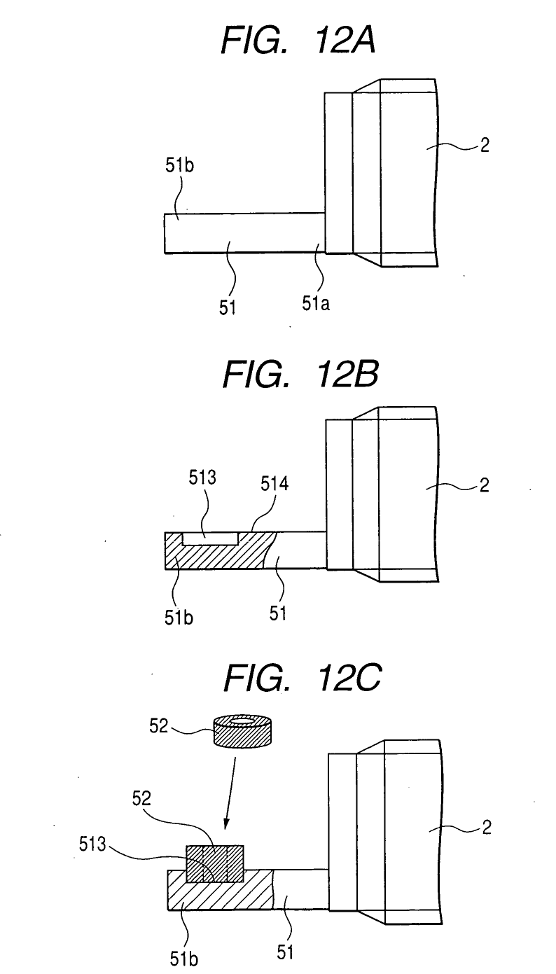

According to the method, as shown in FIG. 12A, the base end portion 51 a of the base member 51, which has not been bent to have the L-shape, is first fixed to the metal shell 2.

Then, as shown in FIG. 12B, a cylindrical recess 513 is centrally formed on the side face 514 of the tip end portion 51b of the base member 51 by cutting (more specifically, by end milling).

After that, as shown in FIG. 12C, the protruding member 52 is fitted in the recess 513 of the tip end portion 51b of the base member 51.

In addition, a resistance or laser welding may further be performed between the protruding member 52 and the base member 51, so as to enhance the joining strength therebetween.

### Eight Embodiment

This embodiment illustrates a method of forming the protruding member 52 of the ground electrode 5.

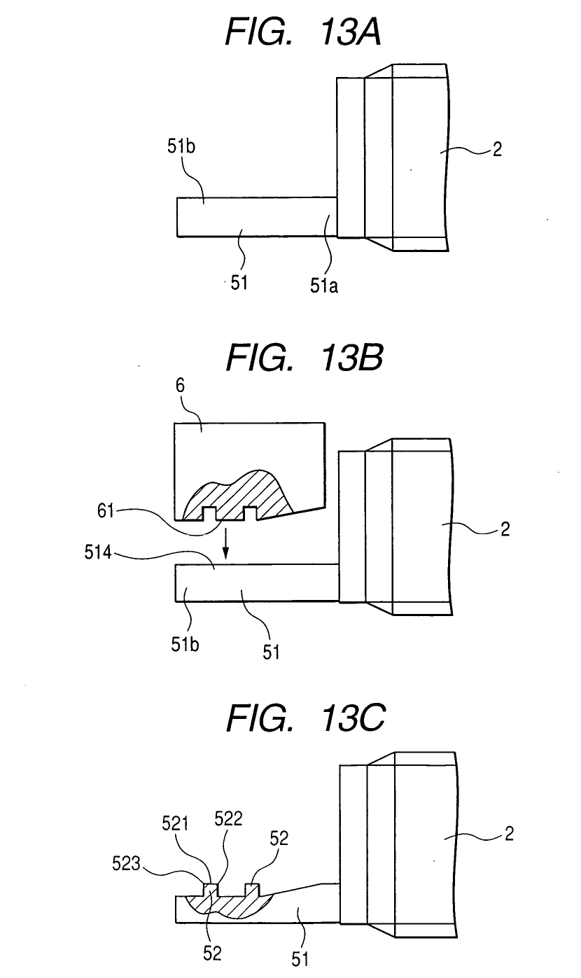

According to the method, as shown in FIG. 13A, the base end portion 51a of the base member 51, which has not been bent to have the L-shape, is first fixed to the metal shell 2.

Then, as shown in FIG. 13B, a press jig 6, which has a die 61 provided therein, is centrally pressed against the side face 514 of the tip end portion 51b of the base member 51.

Consequently, as shown FIG. 13C, the protruding member 52 is integrally formed with the base member 51, through the deformation of the base member 51 during the press.

In addition, the die 61 may have various shapes so as to obtain various desired shapes of the protruding member 52.

While the above particular embodiments of the invention have been shown and described, it will be understood by those who practice the invention and those skilled in the art that various modifications, changes, and improvements may be made to the invention without departing from the spirit of the disclosed concept.

Such modifications, changes, and improvements within the skill of the art are intended to be covered by the appended claims.

What is claimed is:

1. A spark plug for an internal combustion engine comprising:
a metal shell;
an insulator retained in the metal shell;
a center electrode secured in the insulator, the center electrode having an end portion that protrudes from the insulator and has an end edge; and
a ground electrode including a base member fixed to the metal shell and a protruding member joined to the base member, the protruding member protruding from a surface of the base member and having a hollow end face that faces the end portion of the center electrode through a spark gap, the end face of the protruding member having an inner edge and an outer edge, both of which face the end edge of the end portion of the center electrode.

2. The spark plug as set forth in claim 1, wherein,

|B1−B2|≦0.3 mm, where,
B1 is a distance between P0 and P1 and B2 is a distance between P0 and P2,
P0 is any intersection between the end edge of the end portion of the center electrode and an arbitrary hypothetical plane that extends parallel to a longitudinal direction of the spark plug and intersects all of the end edge of the end portion of the center electrode and the inner and outer edges of the protruding member of the ground electrode,
P1 is any intersection between the inner edge of the protruding member of the ground electrode and the arbitrary hypothetical plane, and
P2 is any intersection between the outer edge of the protruding member of the ground electrode and the arbitrary hypothetical plane.

3. The spark plug as set forth in claim 2, wherein |B1−B2|=0.

4. The spark plug as set forth in claim 2, wherein,
if A≧E1, (A−E1)/2≦A/3, else
if A<E1, B1≦F, where,
A is a length of the longest straight line whose end points lie on the end edge of the end portion of the center electrode,
E1 is a length of the longest straight line whose end points lie on the inner edge of the protruding member of the ground electrode, and
F is a distance between the end portion of the center electrode and the base member of the ground electrode in the longitudinal direction of the spark plug.

5. The spark plug as set forth in claim 2, wherein the end edge of the end portion of the center electrode is shaped in a circle, and the protruding member of the ground electrode is shaped in a cylindrical tube so that the inner and outer edges of the protruding member are shaped in circles which are concentric with one another.

6. The spark plug as set forth in claim 5, wherein,
if A≧E1, (A−E1)/2≦A/3, else
if A<E1, B1≦F, where,
A is a diameter of the end edge of the end portion of the center electrode,
E1 is a diameter of the inner edge of the protruding member of the ground electrode, and
F is a distance between the end portion of the center electrode and the base member of the ground electrode in the longitudinal direction of the spark plug.

7. The spark plug as set forth in claim 2, wherein the protruding member of the ground electrode has a protruding height D, which represents a distance between the end face of the protruding member and the base member of the ground electrode in the longitudinal direction of the spark plug, in a range of 0.3 to 1.5 mm.

8. The spark plug as set forth in claim 2, wherein a distance C between the protruding member of the ground electrode and the end portion of the center electrode in the longitudinal direction of the spark plug is in a range of 0.5 to 1.5 mm.

9. The spark plug as set forth in claim 2, wherein the end portion of the center electrode is made of an Ir-based alloy which includes Ir in an amount of not less than 50% by weight and at least one additive and has a melting point of not lower than 2000° C.

10. The spark plug as set forth in claim 9, wherein the at least one additive is selected from Pt, Rh, Ni, W, Pd, Ru, Re, Al, Al₂O₃, Y, and Y₂O₃.

11. The spark plug as set forth in claim 2, wherein the protruding member of the ground electrode is made of a Pt-based alloy which includes Pt in an amount of not less than 50% by weight and at least one additive and has a melting point of not lower than 1500° C.

12. The spark plug as set forth in claim 11, wherein the at least one additive is selected from Ir, Rh, Ni, W, Pd, Ru, and Re.
